(19) United States
(12) Patent Application Publication
(10) Pub. No.: US 2006/0255193 A1
(43) Pub. Date: Nov. 16, 2006

(54) Grinding machine and method of operation

(76) Inventors: Michael L. Hockstra, Mt. Pleasant, MI (US); Mitchell T. Gifford, Blanchard, MI (US); Douglas C. Counts, Saginaw, MI (US); Jeffrey S. Counts, Frankenmuth, MI (US); Michael J. Brennan, Comstock, MI (US); Michael D. Wilde, Cedar Springs, MI (US)

Correspondence Address: REISING, ETHINGTON, BARNES, KISSELLE, P.C., P O BOX 4390, TROY, MI, 48099-4390, US

(21) Appl. No.: 11/417,590

(22) Filed: May 4, 2006

Related U.S. Application Data
(60) Provisional application No. 60/677,571, filed on May 4, 2005.

(51) Int. Cl. B02C 19/00

(52) U.S. Cl. 241/28; 241/101.72

(57) ABSTRACT

A grinding machine for reducing wood objects to fragments. The machine includes a frame that carries an engine and is supported for movement over the ground. An arm is supported on the frame for pivotal movement relative to the frame and the engine and carries a grinding member. The engine drives the grinding member through a drive transmission linkage that is connected between the engine and the grinding member. The drive transmission linkage transmits torque from the engine to the grinding member even as the arm pivots the grinding member relative to the frame and the engine.

### CROSS-REFERENCES TO RELATED APPLICATIONS

This application claims priority in United States Provisional Patent Application Ser. No. 60/677,571, which was filed 4 May 2005 and is incorporated by reference in its entirety into this application.

### STATEMENT REGARDING FEDERALLY SPONSORED RESEARCH OR DEVELOPMENT

Not Applicable

### BACKGROUND OF THE INVENTION

1. Field of the Invention

This invention relates generally to grinding machines and methods of their operation, and more particularly to grinding machines used to reduce stumps into fragments.

2. Description of the Related Art Including Information Disclosed Under 37 CFR 1.97 and 1.98

Stump grinding machines are commonly used to facilitate the removal of tree stumps. A typical grinding machine has a base with an arm extending to a driven grinding wheel arranged for rotation at an end of the arm. Typically, the grinding wheel is moved across the tree stump while being lowered until the entire stump has been removed. The final sweeps of the grinding wheel may be below ground level to ensure that the entire stump has been removed.

Often, the base of the grinding machine has wheels to facilitate movement of the machine from one location to another. The wheels may be driven by a motor, or arranged to free wheel to facilitate towing the grinding machine behind a vehicle. Power to drive the grinding wheel is typically derived from a gasoline or diesel engine. The engine is typically arranged for pivotal and/or horizontal movement with the arm, wherein the engine is commonly mounted on the arm, or at a base of the arm.

The location of the engine either at the base of the arm or thereon tends to locate the center of gravity of the machine toward the grinding wheel. When the engine is mounted to the arm or at its base, the horizontal and vertical movement of the arm, and thus the grinding wheel, is generally restricted. This results largely due to movement of the machine's center of gravity outwardly toward the side of the machine, thus, tending to tip the machine. To compensate for movement of the center of gravity toward the sides of the machine, the machine is typically provided with a wide wheel base, or the range of motion of the arm is restricted. This limits the ability of the machine to navigate narrow confines, and can also limit the horizontal travel of the arm and the vertical arc through which the grinding wheel can move.

### BRIEF SUMMARY OF THE INVENTION

According to the invention a grinding machine is provided for reducing wood objects to fragments. The grinding machine comprises a frame supported for movement over the ground, an engine carried by the frame, an arm operably supported on the frame for pivotal movement relative to the frame and the engine, a grinding member carried by the arm for pivotal movement with the arm. A drive transmission linkage is operably connected between the engine and the grinding member and is configured to transmit torque from the engine to the grinding member even as the arm pivots the grinding member relative to the frame and the engine.

According to another aspect of the invention the drive transmission linkage includes a drive shaft driven by the engine and a driven shaft operatively attached to the drive shaft for rotation with the drive shaft. The driven shaft is arranged for pivotal movement relative to the drive shaft and is arranged in operable communication with the fragmenting assembly to drive the fragmenting assembly.

According to another aspect of the invention the driven shaft pivots relative to the drive shaft in response to the arm pivoting relative to the frame.

According to another aspect of the invention the driven shaft is pivotable through an arc of about 80 degrees relative to the drive shaft.

According to another aspect of the invention the grinding member is pivotable through an arc of about 80 degrees relative to the frame.

According to another aspect of the invention the pivotal movement of the arm relative to the frame includes a yaw component about an arm yaw axis and a pitch component about an arm pitch axis generally perpendicular to the arm yaw axis. Also according to this aspect of the invention the pivotal movement of the driven shaft relative to the drive shaft includes a yaw component about a transmission yaw axis and a pitch component about a transmission pitch axis generally perpendicular to the transmission yaw axis.

According to another aspect of the invention the driven shaft is pivotable through an arc of about 80 degrees relative to the drive shaft in any azimuth and the arm is pivotable through an arc of about 80 degrees relative to the frame in any azimuth.

According to another aspect of the invention the drive transmission linkage includes a constant velocity joint operably coupling the drive shaft to the driven shaft.

According to another aspect of the invention the drive transmission linkage includes a belt drive operably connected between the engine and the grinding member.

According to another aspect of the invention the engine is supported on the frame for movement between engaged and disengaged positions. The grinding member is operable to rotate in response to actuation of the engine when the engine is in the engaged position and the grinding member is inoperable when the engine is in the disengaged position.

According to another aspect of the invention the drive transmission linkage is configured to transmit torque to and rotate the grinding member when the engine is operating in its engaged position. In addition, the drive transmission linkage is configured to prevent rotation of the grinding member when the engine is in its disengaged position.

According to another aspect of the invention the drive transmission linkage includes a belt drive operably connected between the engine and the grinding member. The belt drive comprises a drive pulley supported on the engine for driven rotation, a driven pulley supported on a drive shaft of the transmission linkage that is drivingly connected to the grinding member, and a belt supported between the drive pulley and the driven pulley. The belt is held in tension between the drive and driven pulleys when the engine is in its engaged position, allowing torque transmission from the engine to the drive shaft. The belt is relaxed when the engine is in its disengaged position, generally precluding torque transmission from the engine to the drive shaft.

According to another aspect of the invention the grinding machine further comprises a brake that is actuable to prevent the grinding member from rotating, the brake being automatically actuated when the engine is moved to its engaged position and automatically released when the engine is moved to its disengaged position.

According to another aspect of the invention the brake comprises a disc brake.

According to another aspect of the invention the machine includes a hydraulic manifold supported on the frame and in fluid communication with a source of pressurized hydraulic fluid. Also according to this embodiment the machine includes a swing actuator connected to the arm and configured to pivot the arm about a yaw axis. A swing flow control valve is carried by the manifold and is connected in fluid communication between the swing actuator and the manifold. The swing flow control valve is actuable to direct pressurized hydraulic fluid from the manifold to the swing actuator to pivot the arm about the yaw axis. The machine also includes an arm pitch actuator connected to the arm and configured to pivot the arm about a pitch axis. Still further according to this aspect of the invention the machine includes an arm pitch flow control valve carried by the manifold, connected in fluid communication between the arm pitch actuator and the manifold, and actuable to direct pressurized hydraulic fluid from the manifold to the arm pitch actuator to pivot the arm about the pitch axis.

According to another aspect of the invention the machine includes a relief valve configured to prevent hydraulic pressure from exceeding a predetermined maximum value.

According to another aspect of the invention the frame is supported for movement on wheels. Also according to this aspect of the invention the machine includes a hydraulic steering actuator connected to at least one of the wheels and configured to steer the wheel. The machine also includes a steering flow control valve carried by the manifold, connected in fluid communication between the steering actuator and the manifold, and actuable to direct pressurized hydraulic fluid from the manifold to the steering actuator to steer the machine.

According to another aspect of the invention the frame is supported for movement on wheels, the machine includes at least one hydraulic drive motor drivingly connected to at least one of the wheels, and the machine includes a propulsion flow control valve carried by the manifold. The propulsion flow control valve is connected in fluid communication between the drive motor and the manifold, and is actuable to direct pressurized hydraulic fluid from the manifold to the drive motor to propel the machine across the ground.

According to the invention a method is provided for reducing wood objects to fragments. The method includes providing a grinding machine comprising an engine carried by a frame, an arm operably supported by the frame for pivotal movement relative to the frame and engine, a grinding member carried by the arm for pivotal movement with the arm, and a drive transmission linkage operably connected between the engine and the grinding member. The grinding machine is positioned adjacent a wood object to be fragmented, the arm is actuated to pivotally move the grinding member into engagement with the wood object, and torque is transmitted from the engine to the grinding member via the drive transmission linkage as the arm pivots the grinding member relative to the frame and the engine.

According to the invention another method is provided for reducing wood objects to fragments. This method includes providing a grinding machine comprising an engine carried by a frame and an arm operably supported by the frame for pivotal movement relative to the frame and engine, and a grinding member carried by the arm for pivotal movement with the arm. The grinding machine is positioned adjacent a wood object to be fragmented, the grinding member is actuated by moving the engine from a disengaged position to an engaged position, and then the arm is actuated to pivotally move the grinding member into engagement with the wood object.

### BRIEF DESCRIPTION OF THE SEVERAL VIEWS OF THE DRAWINGS

Some of the objects, features and advantages of the invention will become readily apparent in view of the following detailed description of the presently preferred embodiments and best mode, appended claims, and accompanying drawings, in which:

FIG. 1 is a perspective view of one presently preferred embodiment of a grinding machine;

FIG. 2 is a view similar to FIG. 1 with a guard removed from a portion of a drive transmission linkage of the grinding machine;

FIG. 3 is another perspective view of the grinding machine;

FIG. 4 is a plan view of the grinding machine with a control center of the grinding machine shown in an alternate location;

FIG. 5 is a perspective view of an arm assembly of the grinding machine;

FIG. 6 is another perspective view of the arm assembly;

FIG. 7 is a plan view of the arm assembly;

FIG. 8 is a cross-sectional view taken generally along line 8-8 of FIG. 7 showing a drive shaft operably coupled to a driven shaft;

FIG. 9 is an enlarged fragmentary perspective view of a joint coupling the drive shaft to the driven shaft;

FIG. 10 is a side view of the joint shown attached to the driven shaft;

FIG. 11 is a perspective view of the joint shown removed from the driven shaft;

FIG. 12 is a front view of the joint showing an inner annulus pivoted relative to an outer annulus;

FIG. 13 is a view similar to FIG. 12 showing the inner and outer annulus generally aligned in a coaxial relation with one another;

FIG. 14 is a fragmentary side view showing a carriage and an actuation lever in a first position;

FIG. 15 is a view similar to FIG. 14 showing the carriage and actuation lever in a second position;

FIG. 16 is a fragmentary perspective view showing a portion of a brake system in a disengaged position;

FIG. 17 is view similar to FIG. 16 showing the brake system in an engaged position;

FIG. 18 is a fragmentary side view of the grinding machine showing the control center of the machine;

FIG. 19 is a schematic diagram showing a hydraulic system of the grinding machine; and

FIG. 20 is a fragmentary perspective view of a steering mechanism of the grinding machine.

### DETAILED DESCRIPTION OF THE PREFERRED EMBODIMENTS

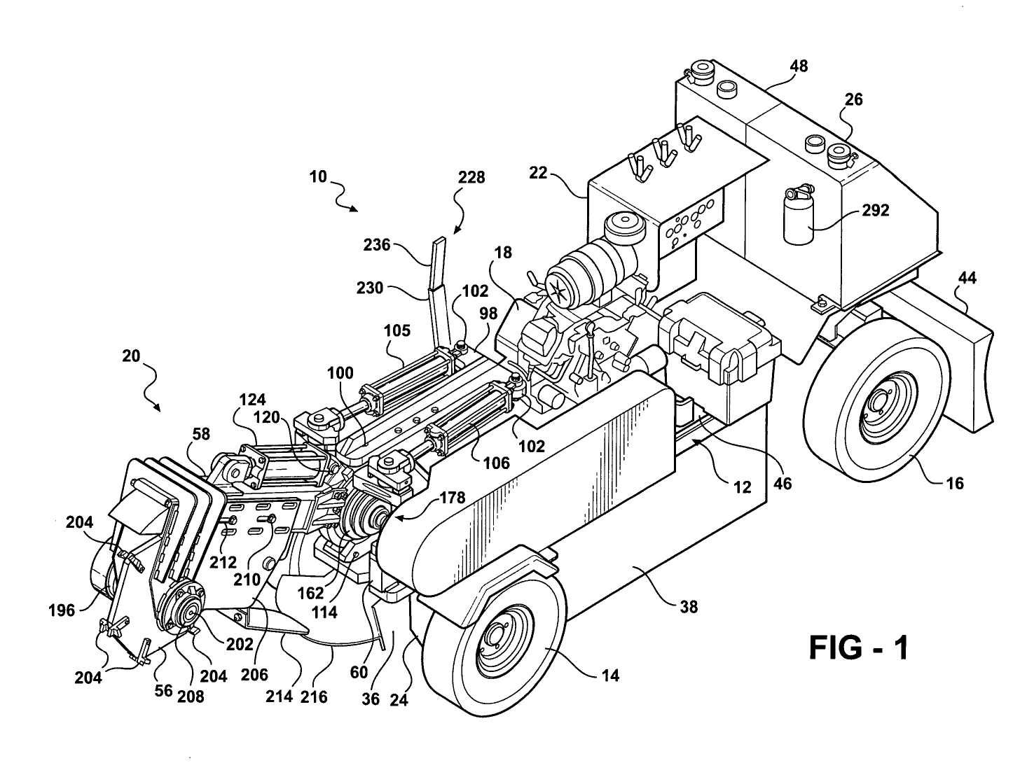

Referring in more detail to the drawings, FIGS. 1-4 illustrate a grinding machine 10 for comminuting or fragmenting wood objects, such as tree stumps, for example, reducing such wood objects into relatively small wood fragments or chips. The machine 10 has a body or frame 12 that may be supported for movement over the ground by a plurality of wheels, represented here as a pair of rear wheels 14 and a pair of front wheels 16, to facilitate moving the machine 10 from one place to another. The frame 12 is arranged to carry a main engine 18 and to support a fragmenting or grinder assembly 20 for operable communication with the engine 18 and for pivotal movement relative to the frame 12 and engine 18. The engine is drivingly connected to the grinder assembly 20 through a drive transmission linkage that transmits torque from the engine to the grinder assembly 20 even as the grinding member is pivoted relative to the frame 12 and the engine 18.

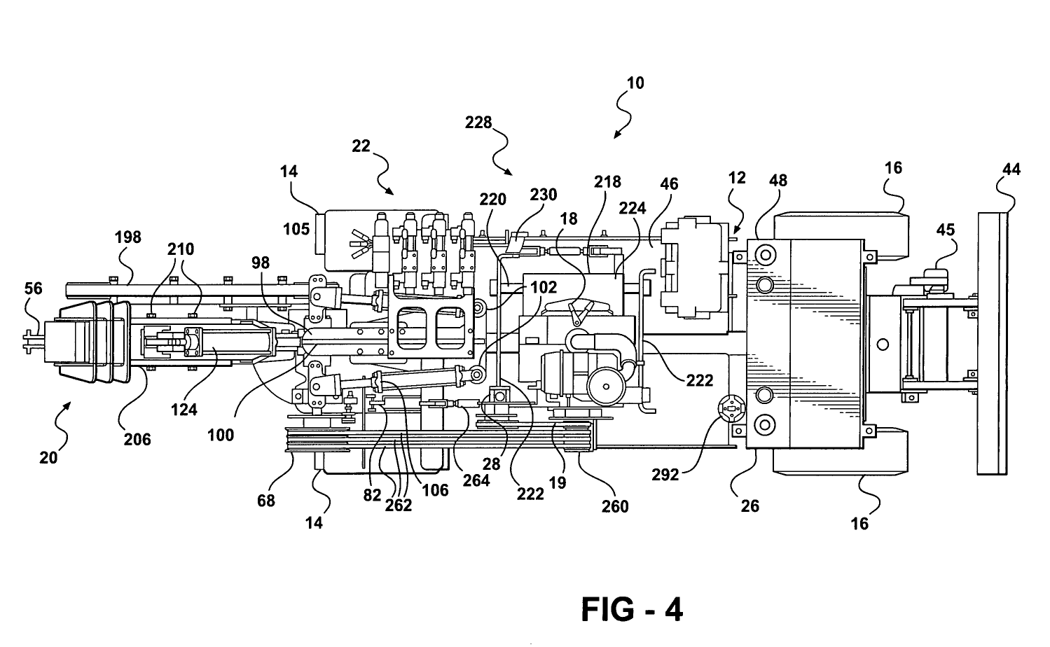

The frame 12 may support a control center or panel 22 (shown in FIGS. 1-3 in one location, and in FIG. 4 in an alternate location) arranged in operable communication with the engine 18 to facilitate operating the machine 10. In addition to being operable via the control panel 22, the machine 10 may be arranged for remote operation, such as by way of a hard wired or wireless remote control (not shown). As such, the machine 10 may be driven or otherwise operated from a distance.

The drive transmission linkage is constructed and connected between the engine 18 and the grinder assembly 20 in such a way as to transmit torque from the engine 18 to the grinder assembly 20 even as the grinder assembly 20 is pivoted relative to the frame 12, i.e., as the grinder assembly 20 is moved generally vertically in an upward and downward pitch direction about an arm pitch axis, and generally horizontally in a left and right sweeping yaw direction about an arm yaw axis, wherein the arm pitch and yaw axes are generally perpendicular one another. Accordingly, the grinder assembly 20 is suitable to grind or fragment wood objects, such as tree stumps, for example, that extend upwardly from a ground surface to a depth below the ground surface.

The rear wheels 14 are preferably each driven by a wheel motor, such as a hydraulically powered motor 24, for example. The wheel motors 24 could otherwise be gasoline, diesel, or electrically powered, if desired. The hydraulically powered wheel motors 24 are arranged for fluid communication with a source of high pressure hydraulic fluid, preferably supplied from a hydraulic oil containing tank 26 carried on the frame 12. The hydraulic fluid or oil may be pumped under high pressure via a fluid pump 28 that is arranged in operable communication with the main engine 18, and that may be driven via a belt 19.

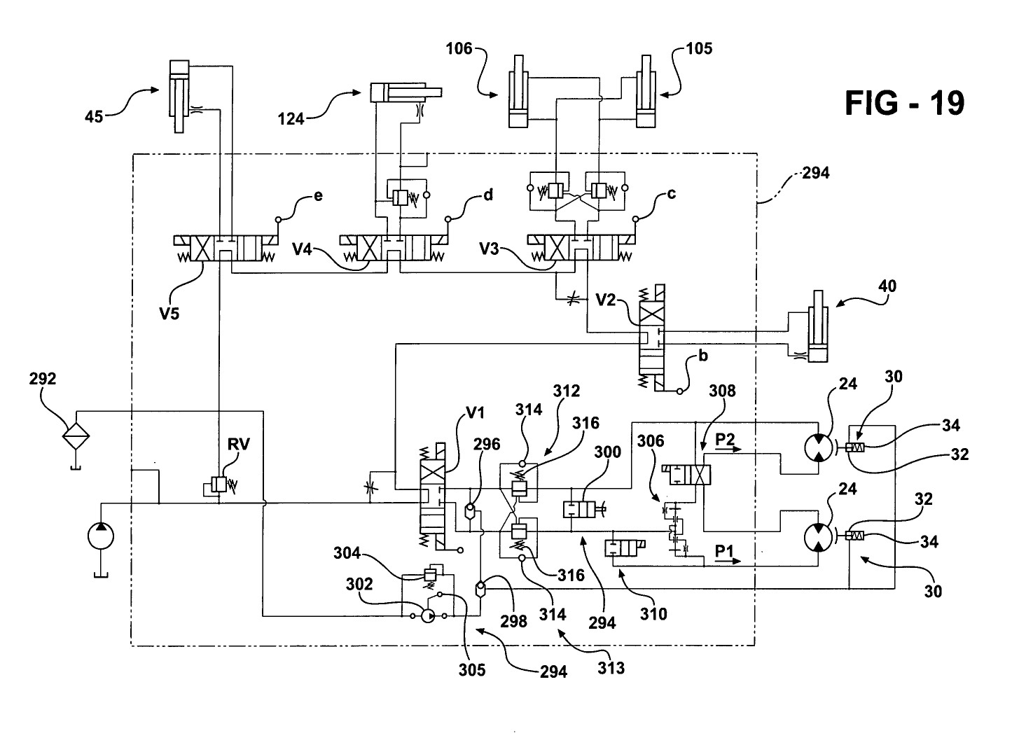

The wheel motors 24 are ordinarily prevented from rotating by a brake mechanism (FIG. 19), represented here, by way of example and without limitations, as a pair of spring-biased brake cylinders 30. Each brake cylinder 30 has a fluid chamber 32 arranged to receive pressurized hydraulic fluid via the pump 28 to overcome the bias of a spring 34, thereby disengaging the brake mechanism, when desired. Each of the wheel motors 24 preferably receives a generally equal flow of hydraulic fluid from the pump 28 to ensure the wheel 14 are driven substantially at the same speed, unless otherwise commanded.

Where each rear wheel 14 driven by a separate motor 24, an area between the wheels is generally left open, enhancing the clearance of the machine 10 relative to the ground, and providing a space 36 for wood fragments to pass during use. The frame 12 may carry a basin 38 to receive the wood fragments as they are ground by the grinding assembly 20. The rear wheels 14 are spaced laterally from one another a sufficient distance to provide stability to the machine 10 while in use and to allow the machine 10 to be transported at increased road speeds, such as by towing or otherwise, though they are close enough to one another to allow the machine 10 to be navigated through relatively tight areas.

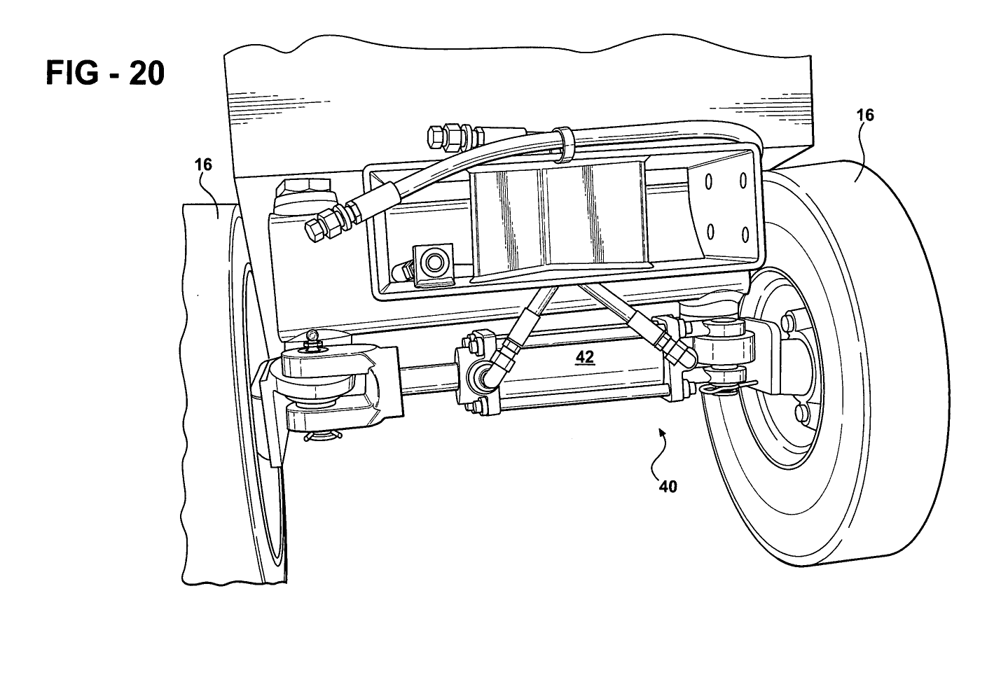

The front wheels 16 are preferably arranged to provide turning movement to the machine 10. They may be free wheeling and in operable communication with one another via a hydraulically actuable steering mechanism 40 as shown in FIG. 20. The steering mechanism 40 could otherwise be pneumatically, mechanically, or electrically actuable, if desired. The front wheels 16 could also be driven similar to the manner in which the rear wheels 14 are driven.

As shown in FIG. 20 the steering mechanism 40 includes a hydraulic steering actuator 42 that may be received generally between the front wheels 16 for fluid communication with the pump 28. Upon commanding the steering actuator 42 via the control panel 22 or remotely, the wheels 16 may be pivoted or turned conjointly with one another in their respective directions to turn the machine 10 in an intended direction.

The machine 10 may include a back-filling and impediment removing device, represented here by a plow or blade 44 operably attached to the rear end of the frame 12. The blade 44 may be arranged for movement upwardly and downwardly via a hydraulic plow actuator 45 (FIG. 4) arranged in fluid communication with the pump 28. The blade 44 could otherwise be arranged for mechanical or electrical actuation, if desired. When moved to its upward position, the blade 44 is spaced from the ground surface sufficiently to allow the machine 10 to move from one place to another, whether in use, or while being transported. When moved to its downward position, the blade 44 can preferably be brought into contact with the ground surface to facilitate back-filling a hole where a tree stump was removed, or to facilitate removing debris, such as rocks, logs, or otherwise, from in front of the machine 10.

The frame 12 may carry a deck or platform 46 to facilitate supporting components of the machine 10. A fuel tank 48 and the hydraulic fluid or oil tank 26 are preferably carried on the frame 12, and are shown here as being fixed to the frame 12 adjacent the front end of the machine 10. The fuel tank 48 is arranged in fluid communication with the main engine 18, and the oil tank 26 is arranged in fluid communication with the pump 28, which in turn, is in fluid communication with the hydraulically actuated components of the machine 10.

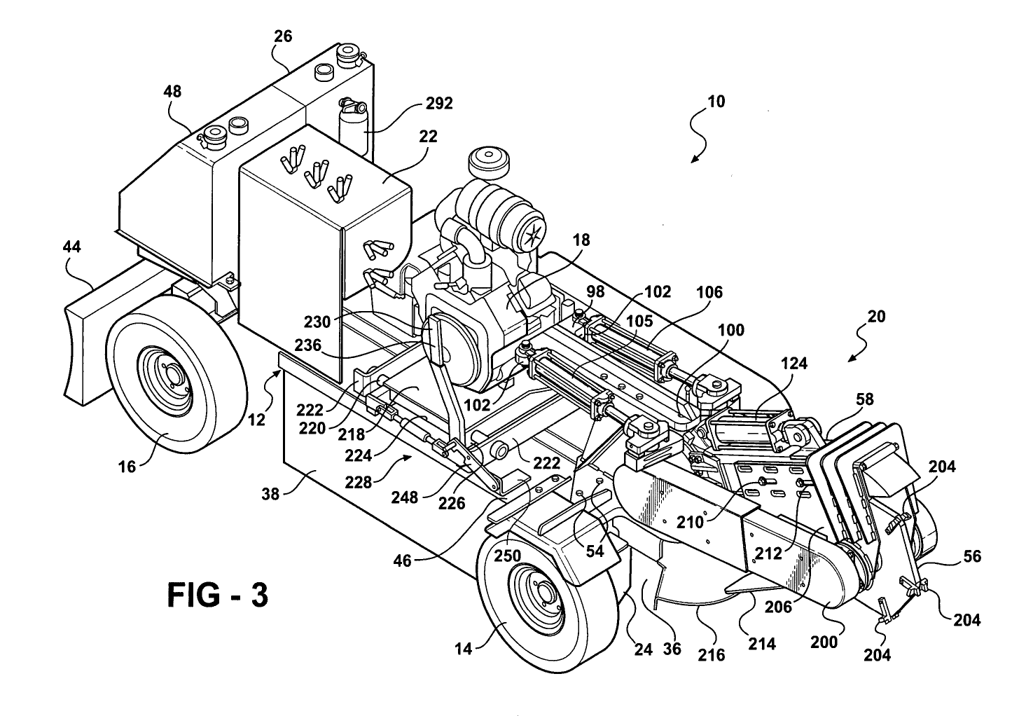

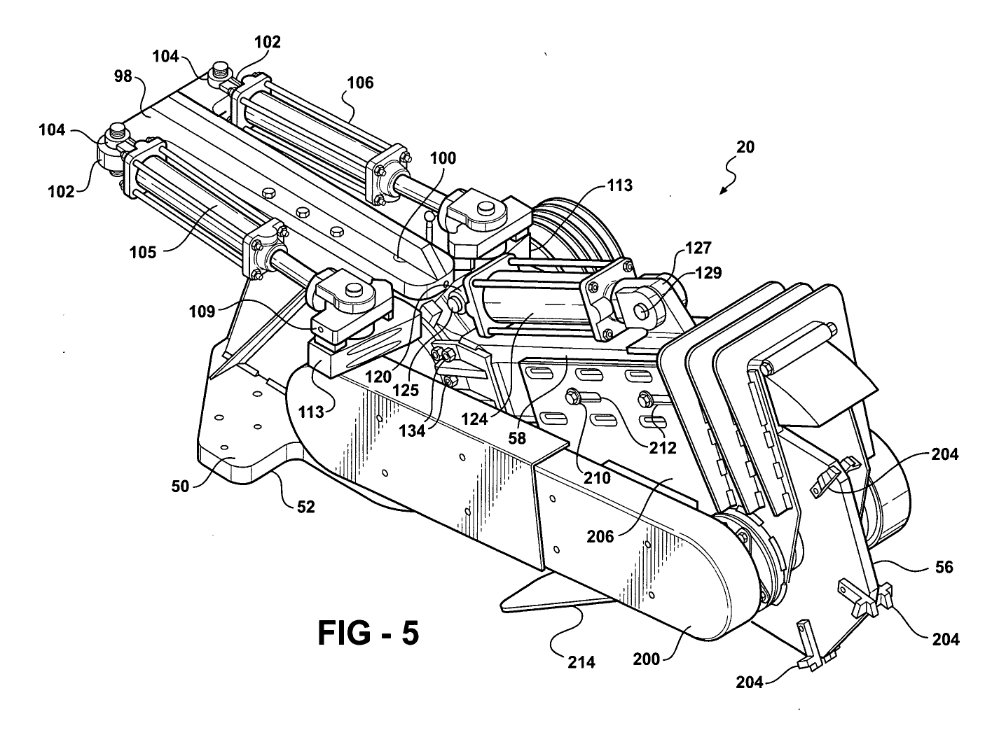

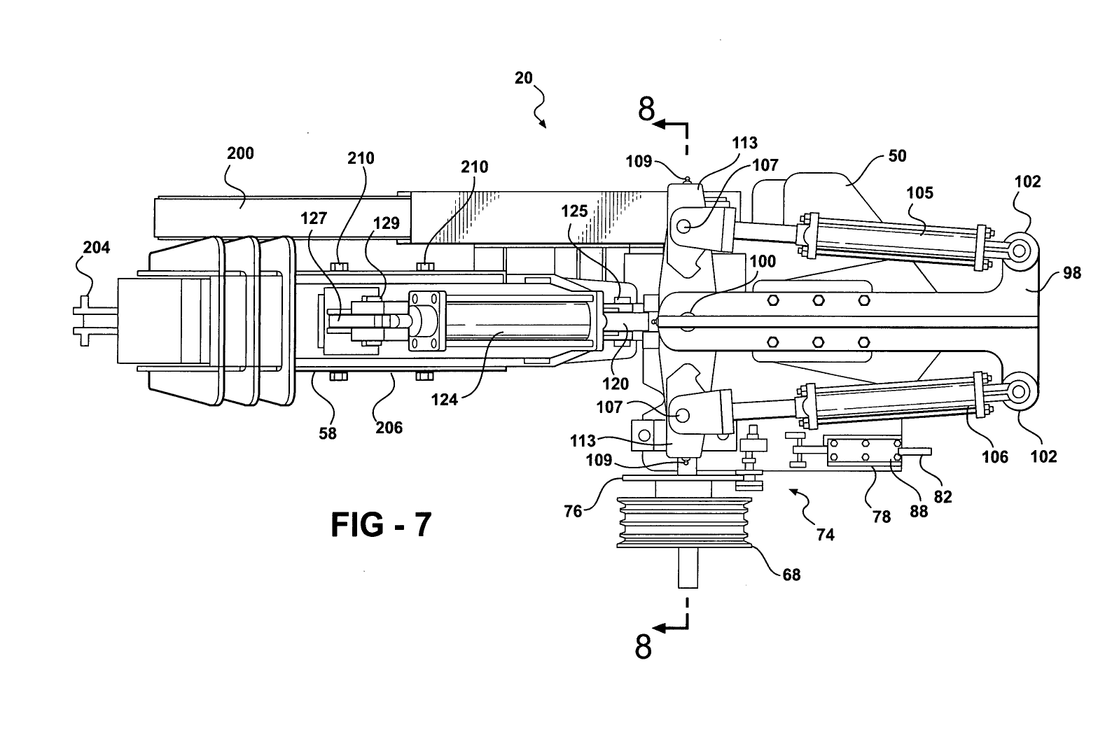

The fragmenting or grinder assembly 20 is operably supported by the frame 12 adjacent the rear end of the machine 10. As best shown in FIGS. 5-8, the grinder assembly 20 may include a support base 50 having a lower surface 52 arranged for fixed attachment to the frame 12 through the use of standard fasteners such as machine bolts 54 as shown in FIG. 3. In other embodiments, any suitable fastening mechanism, including welds, could be used in place of machine bolts.

The base 50 is arranged to operably support a grinding member or cutter 56 for pivotal movement relative to the frame 12 and engine 18 via an arm 58. The arm 58 and cutter 56 are supported by the base 50 for conjoint pivotal movement relative to the frame 12 and engine 18, i.e., upward and downward pitching movement and also swinging left and right lateral yawing movement from one side of the machine 10 to the other.

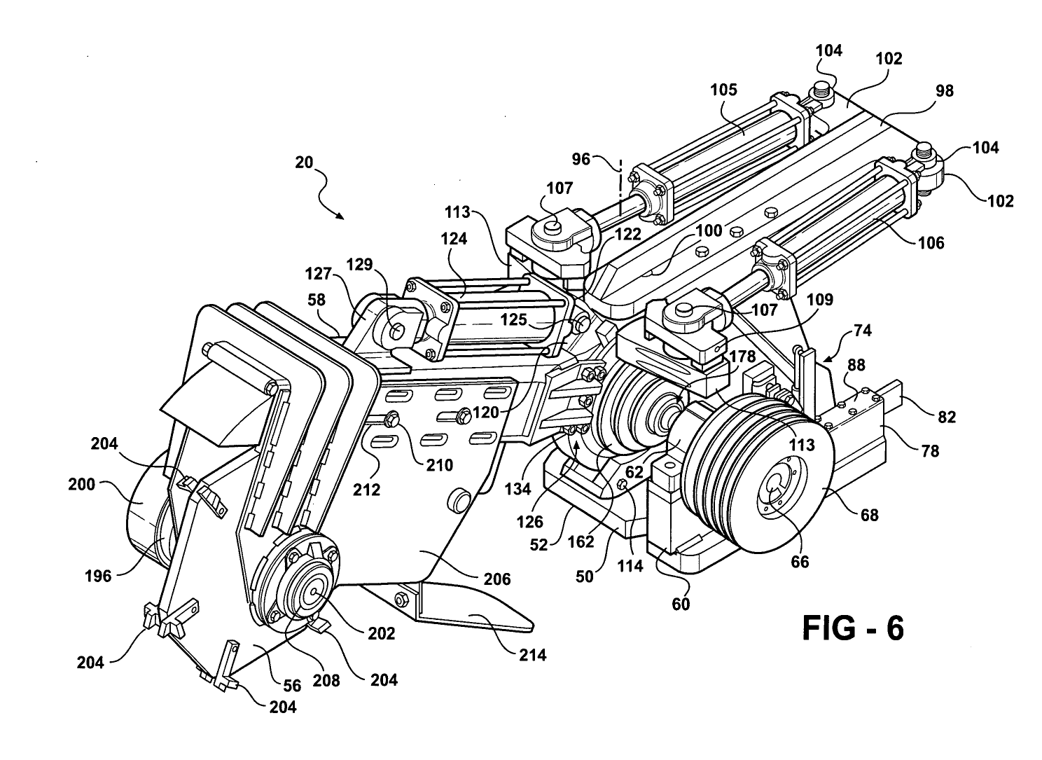

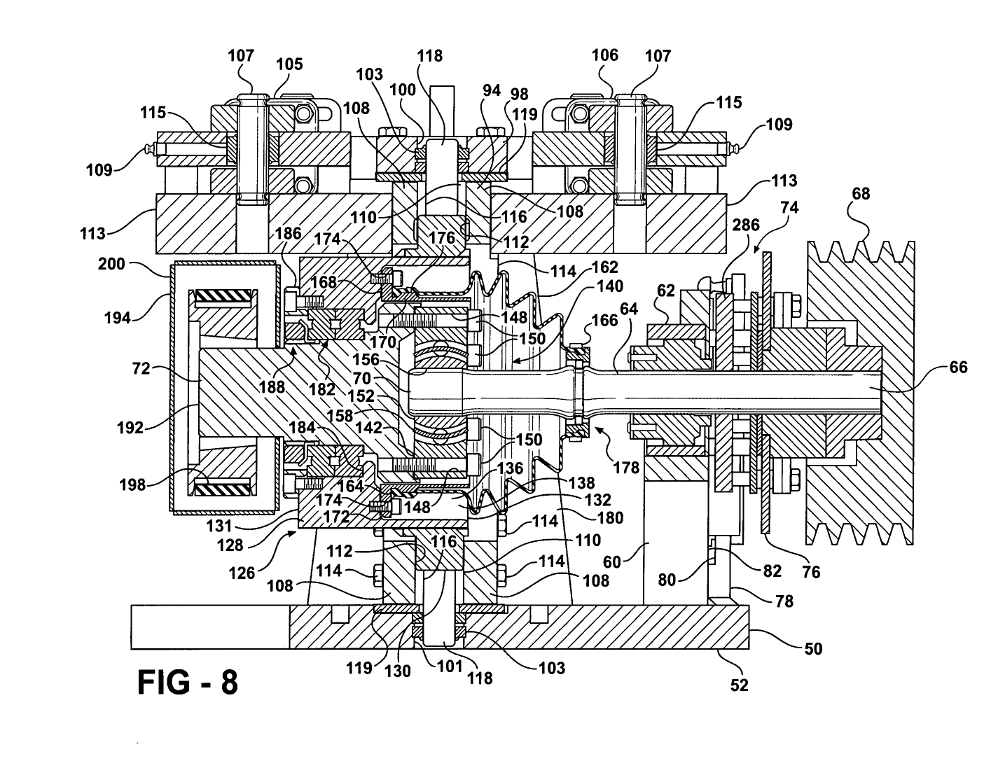

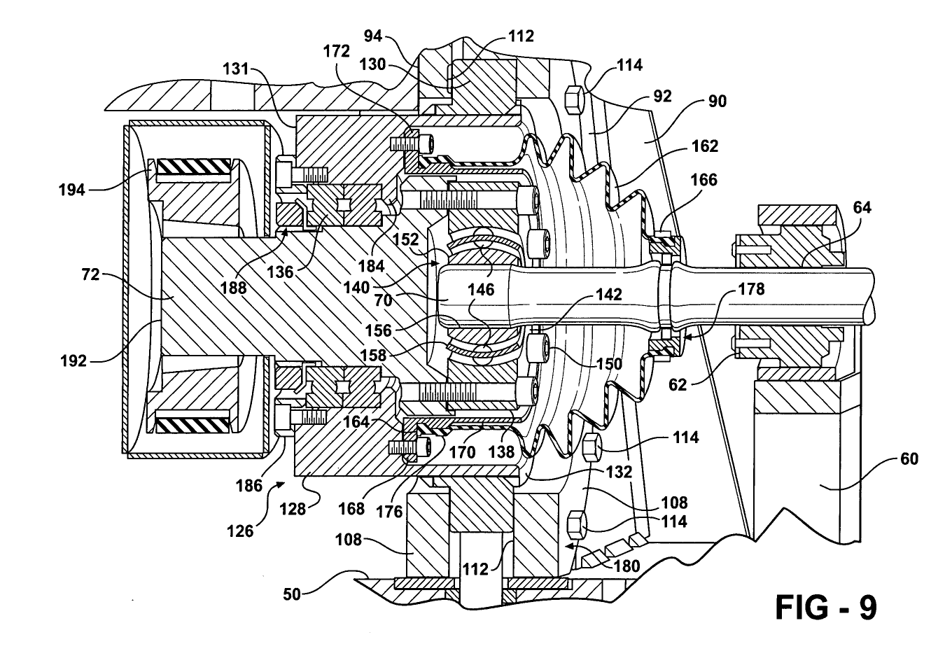

The base 50 preferably has an upstanding mounting block 60 as shown in FIGS. 6, 8, and 9. The mounting block 60extends upwardly from the upper surface of the base 50 to provide a mounting surface for a bearing in the form of a housed bearing or pillow block 62, for example. The pillow block 62 is sized and arranged to receive and support a drive shaft 64 element of the drive transmission linkage therethrough for rotation about a drive shaft axis as shown in FIGS. 8 and 9.

The drive shaft 64 has one end 66 attached to a driven member of the drive transmission linkage such as a serpentine type pulley 68. Another end 70 of the drive shaft 64 is arranged for operable communication with a driven shaft 72 that is supported for rotation about a driven shaft axis and pivotal movement relative to the drive shaft 64. The driven shaft 72 pivots relative to the drive shaft 64 in response to the arm 58 pivoting relative to the frame 12. The pivotal movement of the driven shaft 72 relative to the drive shaft 64 includes a yaw component about a transmission yaw axis and a pitch component about a transmission pitch axis generally perpendicular to the transmission yaw axis.

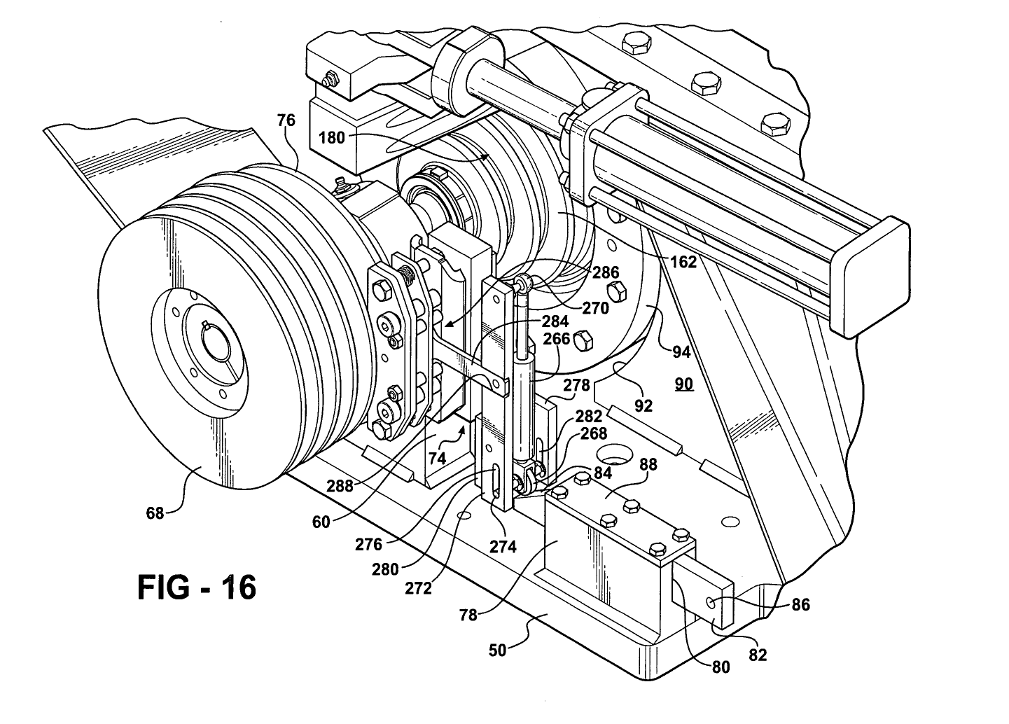

As best shown in FIG. 16, the mounting block 60 also preferably provides a location to mount a brake assembly, represented here as a disc brake assembly 74, for example. The brake assembly 74 is arranged for braking engagement with a rotor or disc 76 that is fixed for conjoint rotation with the drive shaft 64.

As shown in FIGS. 6-8, 16 and 17, a brake actuator guide housing 78 preferably extends upwardly from the base 50 to facilitate actuation of the brake assembly 74. The guide housing 78 may, as is represented here, have a generally U-shaped wall defining a recessed channel 80 in cross section with a lower surface arranged for attachment to the base 50. The recessed channel 80 is sized for sliding receipt of an actuator bar 82. The actuator bar 82 has an inclined cam surface 84 at one end and preferably a through opening 86 at an opposite end. The guide housing 78 preferably has a cover 88 attached over the channel 80 to maintain the actuator bar 82 within the enclosed channel 80 as it slides back and forth.

As best shown in FIGS. 9, 16 and 17, the base 50 has a generally C-shaped support 90 extending upwardly therefrom, with the support 90 having a recess 92 to receive a housing 94. As shown in FIG. 6, the recess 92 allows the housing 94 to pivot about a generally vertical yaw axis 96 as the arm 58 and cutter 56 are commanded to move laterally from side to side. An upper plate 98 is attached to the support 90 via threaded fasteners, for example, though the plate 98 could alternatively be welded or otherwise fastened to the base 50.

One end of the plate 98 preferably defines a portion of the recess 92. An opening 100 is provided adjacent the end of the plate 98 in axial alignment with another opening 101 in the base 50 to facilitate attachment of the housing 94 for pivotal movement relative to the base 50. Another end of the upper plate 98 may be T-shaped, defining legs 102 that extend opposite one another. The legs 102 preferably have through-openings 104, as shown in FIGS. 5 and 6, to provide attachment locations for two swing actuators 105, 106.

As best shown in FIGS. 8 and 9, the housing 94 has a pair of laterally spaced, generally C-shaped outer plates 108. A generally C-shaped mid-plate or spacer 110 is received between the outer plates 108 to define a C-shaped channel 112 between the outer plates 108. The outer plates 108 and the spacer 110 have a plurality of aligned through-openings that facilitate attaching the plates 108 to opposite sides of the spacer 110, such as with standard machine bolts and nuts 114.

To facilitate the left and right swinging yaw movement of the grinder assembly 20, two arms 113 extend laterally outwardly from the outer plates 108 of the housing 94 as shown in FIG. 8and provide attachment locations for one end of each of the two swing actuators 105, 106. The ends of the swing actuators 105, 106 may be attached in their respective locations via bolts or pins 107.

To minimize friction and reduce corrosion, bearings 115 may be housed within a portion of the arms 113 to receive the pins 107. Lubrication fittings 109 may be incorporated in a portion of the arms 113 to facilitate lubricating the bearings 115, thereby extending their useful life. The swing actuators 105, 106 are arranged for operable communication with one another so that when one actuator is moved to an extended position, the other actuator is moved to a retracted position, thereby enabling the grinder assembly 20 to be yawed from left to right in a smooth and efficient manner about the arm yaw axis.

As shown in FIG. 8, the spacer 110 has a pair of through-openings 116 arranged for axial alignment with the openings 100, 101 in the upper plate 98 and the base 50, respectively. A pair of pivot pins 118 may be fixed in the through-openings 116 of the spacer 110. The two pins of the pivot pin pair 1I 8extend coaxially with one another outwardly from the spacer 110 for receipt in the openings 100, 101 in the upper plate 98 and base 50, respectively. As such, the housing 94 is captured for pivotal movement within the recess 92.

To facilitate pivotal movement of the housing 94, a pair of bearings 103 may be received in the openings 100, 101, and for journaled receipt of the pins 118. To further reduce friction and to facilitate pivotal movement of the grinder assembly 20, a pair of friction reducing thrust plates 119 may be received between the housing 94 and the upper plate 98, and the housing 94 and the base 50. The spacer 110 may have an outwardly extending ear or flange 120 with a through opening 122 for attachment of an arm pitch actuator 124.

The arm pitch actuator 124 may, as is represented here, include a hydraulic cylinder. The arm pitch actuator 124 facilitates the upward and downward pivoting movement of the grinder assembly 20 about the arm pitch axis. The arm pitch actuator 124 has one end attached to the ear 120 and another end arranged for attachment to the arm 58. The end attached to the ear 120 may be attached via a bolt or pin 125, while the other end may be attached to a flange 127 extending upwardly from the arm 58 preferably using a bolt or pin 129.

To minimize friction, bearings may be housed within the respective flanges 120, 127. The pins 125, 129 that attach the arm pitch actuator 124 to the ear 120 and arm 58 are received through the bearings. Lubrication fittings may be incorporated in communication with the bearings, thereby extending the useful life of the bearings. The arm pitch actuator 124 has a plunger that is actuable for movement between an extended position, wherein the grinder assembly 20 is pivoted to a lowered cutting position, and a retracted position, wherein the grinder assembly 20 is pivoted to a raised position.

The arm 58 has one end arranged for attachment to a generally cylindrical knuckle 126 as shown in FIGS. 6, 8, and 9Another end of the arm 58 is arranged to carry the cutter 56. As best shown in FIGS. 8 and 9, the knuckle 126 has a generally cylindrical body 128 with a circumferential flange 130 extending radially outwardly from an outer surface of the body 128 generally between opposite ends 131, 132 of the body 128, and adjacent one end 132 of the body 128. The flange 130 may be sized for a slightly loose fit within the channel 112 of the housing 94 to allow the knuckle 126 to rotate relative to the housing 94. A portion of the flange 130 may include through openings arranged for alignment with through openings adjacent the end of the arm 58 to facilitate attachment of the arm 58 to the knuckle 126 via standard machine bolts and nuts 134 as shown in FIGS. 5 and 6.

The knuckle body 128 has a through-bore 136 sized to receive the drive shaft 64 and driven shaft 72. The bore 136 has an enlarged portion 138 adjacent one end 132 of the body 128 sized to receive a pivotal coupler or constant velocity joint (CVJ) 140 as shown in FIGS. 8-13. The CVJ 140 operably joins the drive shaft 64 to the driven shaft 72 and allows the driven shaft 72 to pivot relative to the drive shaft 64. The CVJ 140 substantially maintains the respective longitudinal drive shaft and driven shaft axes of the drive shaft 64 and driven shaft 72 in an intersecting relation with one another while allowing the drive shaft and driven shaft axes to be inclined relative to one another. The CVJ 140 allows the driven shaft 72 to pivot through an arc of about eighty (80) degrees in any azimuth, the arc being centered on an imaginary extension of the drive shaft axis toward the driven axis. In other words, the CVJ 140 generally allows the driven shaft 72 to pivot about forty (40) degrees relative to the drive shaft 64 in two opposite radial directions in any azimuth. As such, the cutter assembly 20 is generally able to sweep an arc of about eighty (80) degrees, in any azimuth, relative to the engine 18 and frame 12.

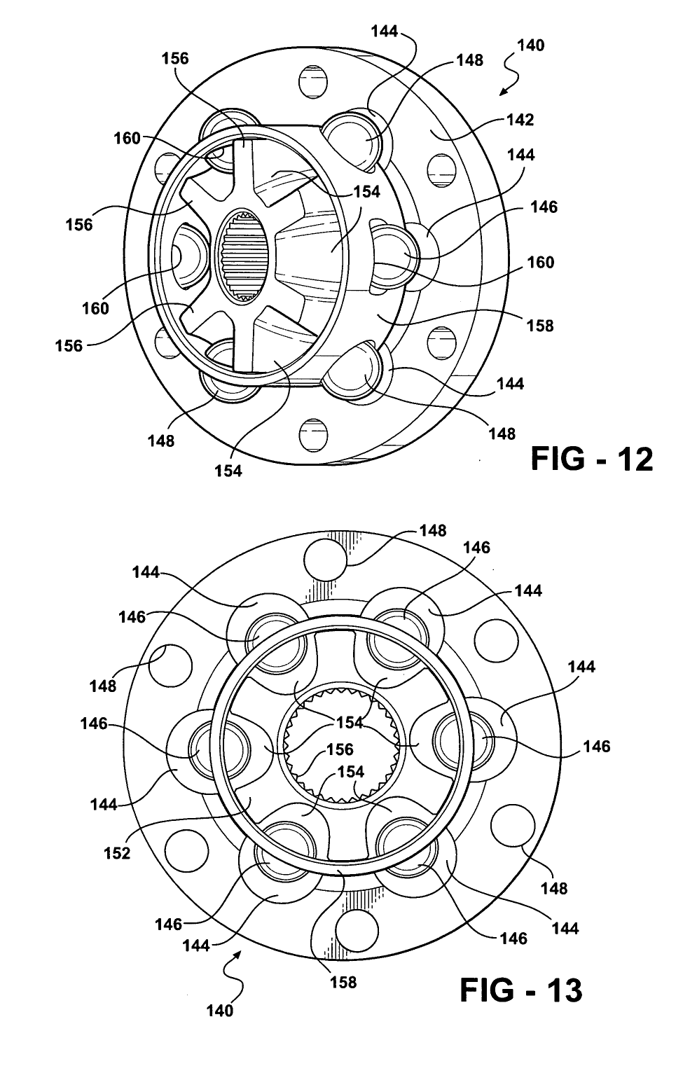

As shown in FIGS. 12 and 13, the CVJ 140 has an outer annulus 142 with a plurality of arcuate, concave scallops 144 formed in an inner surface of the annulus 142 and extending between opposite sides of the annulus 142. The scallops 144 are preferably spaced radially equidistant from one another and are sized for rolling receipt of a separate ball 146 of predetermined size. As such, each ball 146 is permitted to roll along a surface of the respective scallop 144 in a generally circular arc between the sides of the annulus 142. The outer annulus 142 preferably has a plurality of circumferentially spaced through openings 148 to facilitate attaching the outer annulus 142 to the driven shaft 72. As shown in FIGS. 8 and 9, standard machine bolts 150 may be used to attach the outer annulus 142 to the driven shaft 72, though any suitable fastening mechanism could be used.

The CVJ 140 includes an inner annulus 152 having a plurality of arcuate, concave scallops 154 formed in an outer surface of the annulus 152 and extending between opposite sides of the annulus 152. The scallops 154 are spaced for radial alignment with the scallops 144 in the outer annulus 142 to receive the balls 146 between them. As such, the balls 146 are permitted to roll along the scallops 144, 154 generally between the opposite sides of the inner and outer annulus 152, 142 in a generally circular arc as the inner annulus 152 and outer annulus 142 pivot out of axial alignment with one another. Though the balls 146 allow the inner and outer annulus 152, 142 to pivot relative to one another, they are sized to inhibit rotation of the inner and outer annulus 152, 142 relative to one another so that rotation of the inner annulus 152 causes conjoint rotation of the outer annulus 142, and thus, the driven shaft 72.

The inner annulus 152 preferably has a bore 156 sized for receipt of the drive shaft 64 within it. The bore 156 may be sized for a close or tight fit of the drive shaft 64, and more preferably has inwardly extending splines arranged for mating engagement with outwardly extending splines adjacent an end of the drive shaft 64. As such, any rotation of the drive shaft 64 preferably causes conjoint rotation of the inner annulus 152, thus causing conjoint rotation of the outer annulus 142 and the driven shaft 72.

To maintain the balls 146 between the inner annulus 152 and outer annulus 142, a cage 158 having a convex, spherical outer surface and a concave spherical inner surface is sized for loose receipt between the outer annulus 142 and inner annulus 152. The cage 158 has a plurality of openings 160, preferably enclosed, and sized for loose receipt of the balls 146. The openings 160 allow the balls 146 to rotate freely as the inner annulus 152 pivots relative to the outer annulus 142, and prevent the balls 146 from rolling uncontrollably along the scallops 144, 154 and out from between the inner and outer annulus 152, 142.

The CVJ 140 may be covered at least in part by a protective cover or boot 162. The boot 162 may be constructed from a flexible polymeric material, such as rubber, for example, and as shown in FIGS. 8 and 9, extends between an enlarged open end 164 sized for operable attachment to the knuckle body 128, and a reduced open end 166 preferably sized for operable sealing engagement with the drive shaft 64. The enlarged end 164 may be carried by a relatively rigid cylindrical shroud 168, wherein the shroud 168 has a cylindrical wall 170 sized for close receipt within the enlarged end 164 to provide added support to the boot 162, and may be sized to extend at least partially over the CVJ 140 to provide added protection to the CVJ 140. The shroud 168 preferably has a radially outwardly, circumferentially extending flange 172 with a plurality of through openings 174 to facilitate attachment of the boot 162 and shroud 168 to the knuckle 126. The shroud 168 preferably has a circumferential lip 176 sized for snapping or snug engagement with the enlarged end 164 of the boot 162 to facilitate maintaining the boot 162 in attached relation to the shroud 168. The reduced end 166 may be sized to receive a bearing and seal assembly 178 to allow relative rotation between the drive shaft 64 and the boot 162, while also inhibiting dust and other debris from entering the boot 162. The wall of the boot 162 preferably has a folded or accordion shaped section 180 to allow the boot 162 to flex, thereby facilitating pivotal movement of the driven shaft 72 relative to the drive shaft 64.

To facilitate rotation of the driven shaft 72 relative to the knuckle 126, the bore 136 of the body 128 adjacent the end 131 may receive a bearing, and may, as shown here, by way of example and without limitations, receive a pair of sealed bearings 182. The bearings 182 have outer rings preferably sized for a line-to-line or press fit within the bore 136, wherein the bore 136 preferably has a counter bore 184 to facilitate axially locating the bearings 182. The bearings 182 have inner rings preferably sized for a line-to-line or press fit on a journal portion of the driven shaft 72.

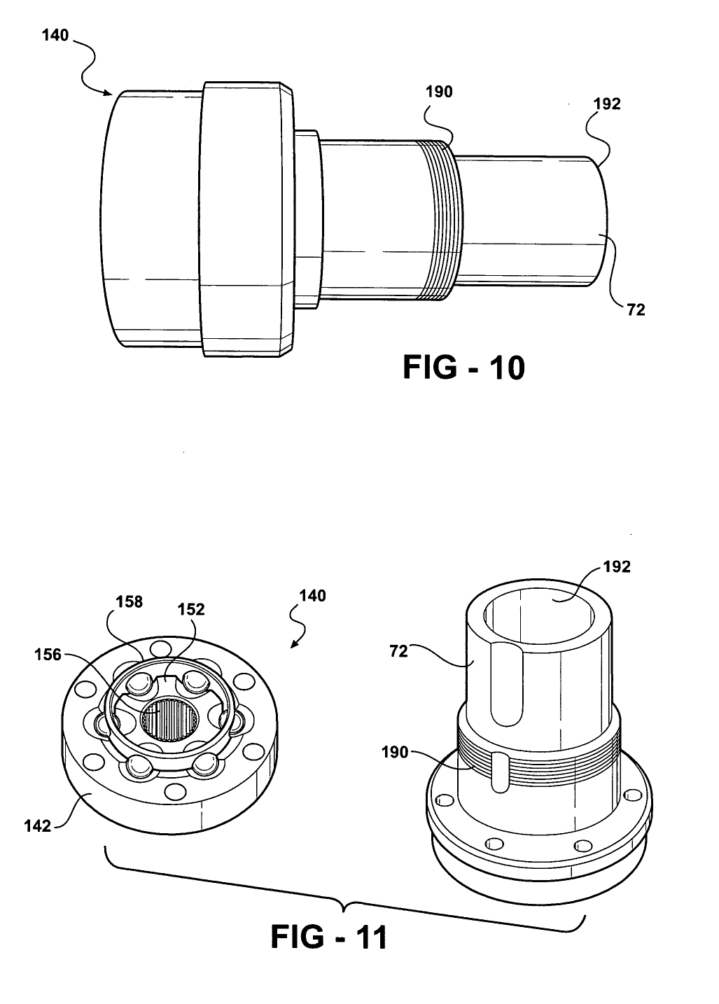

To facilitate maintaining the outer rings in their proper location, a retaining ring 186 may be fastened to the body 128 for abutment with the adjacent outer ring. A nut and lock ring assembly 188 may be used to facilitate maintaining the outer rings in their proper location. The nut and lock ring assembly 188 may, as shown in FIGS. 10 and 11, be threaded onto a threaded portion 190 of the driven shaft 72 for conjoint rotation with the driven shaft 72.

The driven shaft 72 extends axially outwardly from the knuckle 126 to a free end 192 that is adapted to carry a drive member. As shown in FIGS. 8 and 9, as the drive member may include a timing pulley 194. With the outer annulus 142 of the CVJ 140 being attached to the driven shaft 72, the drive member 194 rotates conjointly with the driven shaft 72 in response to rotation of the drive shaft 64, regardless of the angle of inclination between the drive shaft 64 and driven shaft 72. The drive member 194 is arranged in operable communication with a driven member, which, as shown here, may be another timing pulley 196. The driven member 196 is in operable communication with the drive member 194, such as through a timing belt 198, for example, to facilitate rotating the cutter 56. The relative drive ratio of the drive member 194 to the driven member 196 can be selected as desired. Preferably, a guard 200 is supported to cover the drive member 194, driven member 196, and belt 198.

The cutter 56 is operably supported on a shaft 202 adjacent a free end of the arm 58. The cutter 56 may, as shown in FIGS. 5-7, include a generally circular disk having radially outwardly extending cutter inserts or teeth 204 for comminuting or fragmenting wood product. The teeth 204 may be removable from the cutter disk 56 to extend the useful life of the disk 56, and to reduce the overall cost associated with servicing the machine 10 upon the teeth 204 becoming worn. The disk 56 may be arranged for fixed attachment to the shaft 202 for conjoint rotation with the shaft 202. The shaft 202 may be sized for journaled rotation adjacent the end of the arm 58.

To facilitate supporting the cutter disk 56 for rotation, a housing 206, generally U-shaped in cross section, may be attached adjacent the end of the arm 58, with the housing 206 arranged to support bearings 208 sized to journal the shaft 202. The housing 206 may be attached to the arm 58 via standard fasteners 210 and the housing 206 may be constructed for adjustment along the arm 58 via a plurality of slots 212 sized for receipt of the fasteners 210. As such, the driven member 196 can be readily adjusted for optimal positioning relative to the drive member 194 to ensure the belt 198 is properly tensioned.

A first deflector plate 214 may be attached to the housing 206 to facilitate directing wood fragments into the basin 38 beneath the frame 12. The first deflector 214 may be fixed to a lower portion of the housing 206 for conjoint movement with the arm 58 upwardly, downwardly, and from left to right. The first deflector 214 can be arranged for communication with a second deflector 216 that is carried by the frame 12 and that may be hinged to the frame 12 for upward and downward pivotal movement in response to the movement of the first deflector 214. The second deflector 216 may be shaped to allow the first deflector 214 to pivot left and right, while remaining in communication with the second deflector 216. Preferably, the first deflector 214 supports the second deflector 216 in use, and can be detached or uncoupled therefrom for storage or transportation. The second deflector 216 could be used in combination with or replaced by a pair of deflector shields, such as a rubber sheets, for example, carried by the arm 58.

The main engine 18 may be a 25-35 hp gas or diesel engine and may be carried on the platform 46 for movement along a portion of the length of the machine 10 relative to the frame 12 and the grinder assembly 20 between an engaged position and a disengaged position. The main engine 18 may be supported by a carriage 218 that is carried on a pair of laterally spaced rails 220 for movement along the rails 220 between the engaged and disengaged positions. As the carriage 218 moves or slides along the rails 220, the main engine 18 moves conjointly with the carriage 218. The rails 220 are preferably mounted to the platform 46 in parallel relation to one another at a predetermined height via upstanding support blocks 222 adjacent opposite ends of the rails 220. The carriage 218 has an upper surface 224 sized for mounting the main engine 18 on the carriage 218. The carriage 218 also includes front and rear upstanding supports 226 that have through openings sized for sliding receipt of the rails 220. To facilitate moving the carriage 218 linearly along the rails 220, an actuator 228 may be arranged in operable communication with the carriage 218.

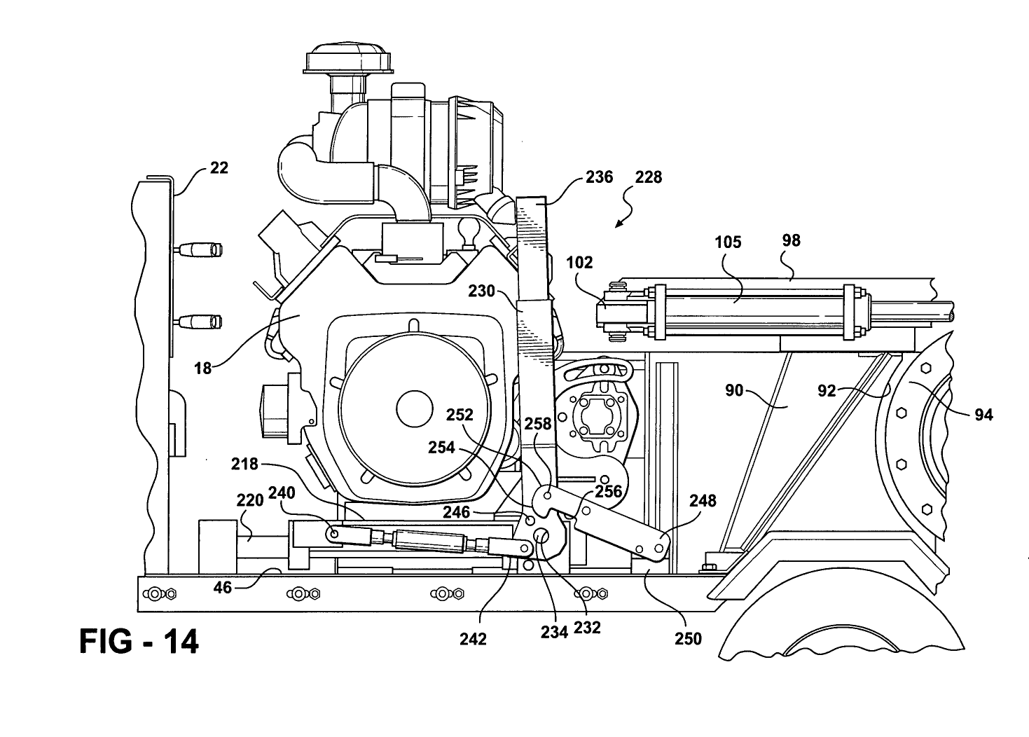

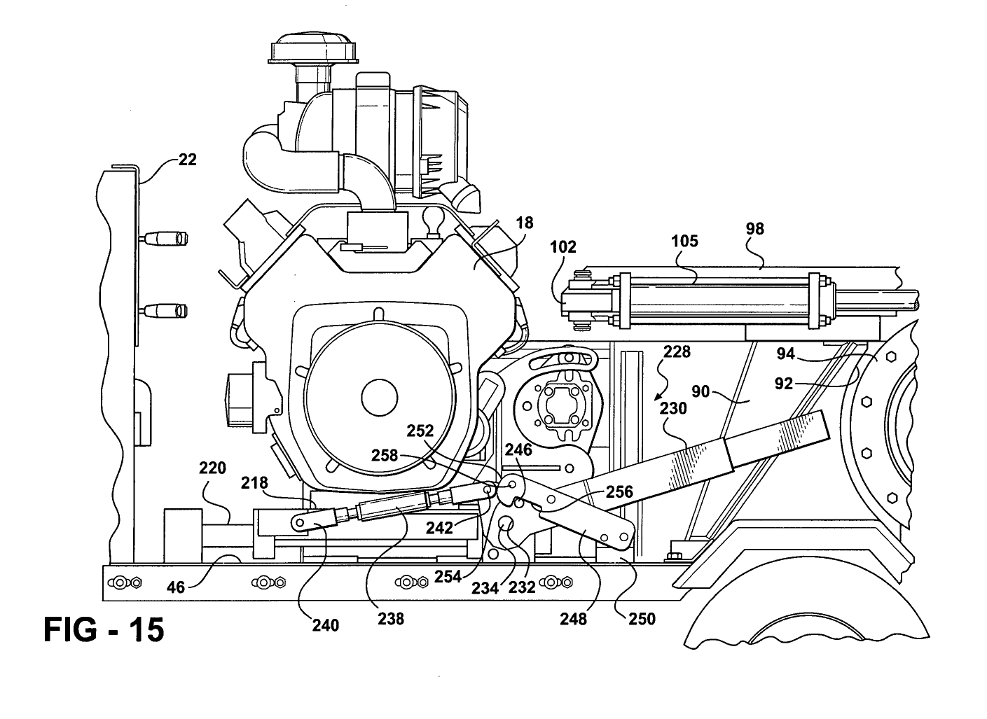

As best shown in FIGS. 14 and 15, the actuator 228 may be constructed as a mechanism having a lever 230 in operable communication with the carriage 218 for pivotal movement between a first position shown in FIG. 14 and a second position shown in FIG. 15. The lever 230 has a through-opening 232 adjacent one end sized for receipt of a pin 234 extending outwardly from one of the carriage support blocks 222. The other end of the lever 230 provides a handle 236 by which the lever may be pivoted about the pin 234. The lever 230 is in operable communication with the carriage 218 preferably through a linkage, represented here, by way of example and without limitations, as a turnbuckle 238. One end of the turnbuckle 238 has a clevis 240 pivotally attached to the carriage 218, and the other end of the turnbuckle 238 has a clevis 240 pivotally attached adjacent the end of the lever 230, such as with a pin or bolt, for example. The point of attachment of the clevis 242 to the lever 230 creates a camming movement as the lever 230 is pivoted about the pin 234, thereby causing the carriage 218, and thus the engine 18 to move along the rails 220 in response to movement of the lever 230. When the lever 230 is moved to the first position as shown in FIG. 14, the engine 18 is moved to its engaged position toward the front end of the machine 10. When in the lever 230 is moved to the second position as shown in FIG. 15, the engine 18 is moved to its disengaged position in the direction of the grinder assembly 20 at the rear or back end of the machine 10. The turnbuckle 238 is adjustable to increase and decrease its effective length, as necessary, by rotating a mid-portion of the turnbuckle 238, such that the position of the carriage can be adjusted when the lever 230 is moved between its first and second positions.

As shown in FIGS. 14 and 15 the lever 230 may include a pin 246 that extends laterally outwardly from the lever 230 for cooperation with a lock arm 248. The lock arm 248 is attached to the platform 46 for pivotal movement via a bracket 250. The lock arm 248 has a free end 252 with a cam surface 254 arranged for camming engagement with the pin 246 on the lever 230. The pivotal movement of the lock arm 248 may be restricted so the pin 246 engages the cam surface 254 as the lever 230 is moved from the first position toward the second position. As such, the pin 246 on the lever 230 causes the lock arm 248 to pivot slightly as it engages the cam surface 254. The lock arm 248 has a notch or recess 256 for locking receipt of the pin 246 as the lever 230 is moved to the second position. As such, when the pin 246 slides along the cam surface 254, it eventually slips into the recess 256 to lock the lever 230 in its second position.

The lock arm 248 may include a laterally outwardly extending handle 258 to facilitate moving the lock arm 248 out of locked engagement with the pin 246, thereby allowing the lever 230 to be moved to the first position, as desired. The lock arm 248 remains locked in the second position until the lock arm 248 is physically commanded to release from the pin 246. As such, the engine 18 remains in its disengaged position and the cutter 56 remains idle until the lock arm 248 is manually moved out of locking engagement with the pin 246 on the lever 230. The engine 18 is in operable communication with the pump 28 to provide power to pump the hydraulic fluid with the oil tank 26 to the components of the machine 10, as commanded.

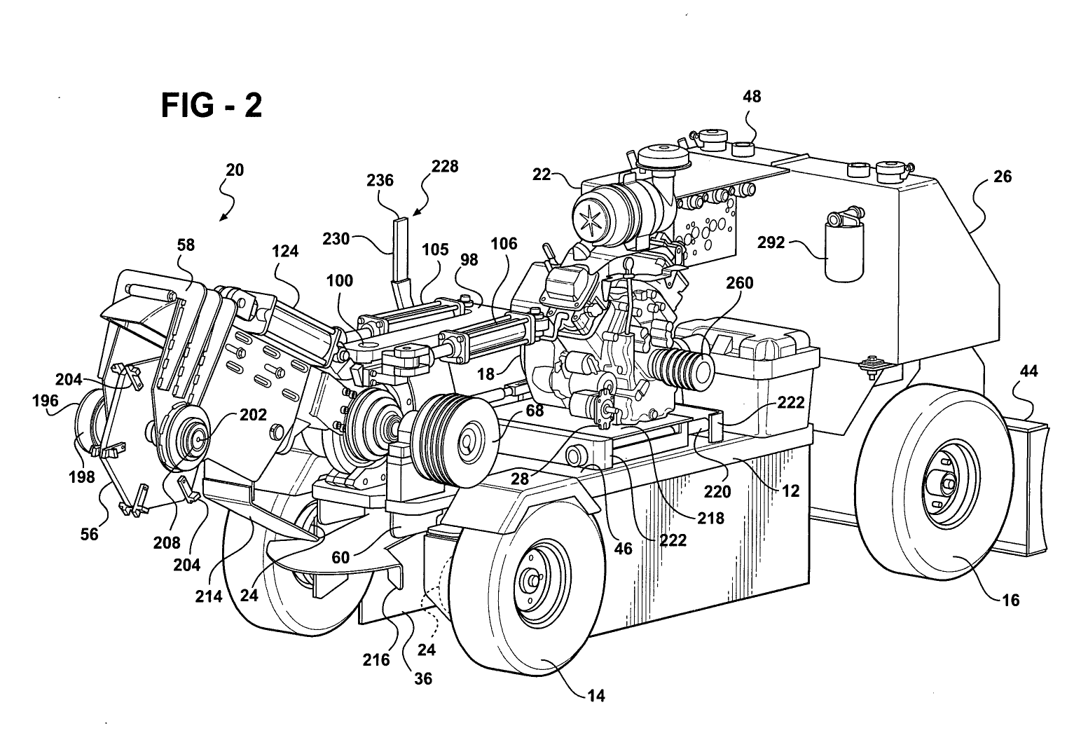

The drive transmission linkage includes a belt drive operably connected between the engine 18 and the grinding member. The engine 18 has an output shaft connected to a drive member of the drive transmission linkage. The drive member of the linkage is represented here, by way of example and without limitations, as a serpentine pulley 260 as shown in FIG. 2. The drive member 260 is arranged for operable communication with the driven member 68 on the drive shaft 64, such as via a serpentine belt or plurality of belts 262, for example. When the lever 230 is moved to the first position, the drive member 260 is move away from the driven member 68, thereby placing the belt 262 under a predetermined tension, causing the driven member 68 to rotate in response to rotation of the drive member 260 and allowing torque to be transmitted from the engine 18 to the drive shaft 64. When the lever 230 is moved to the second position, the drive member 260 is moved toward the driven member 68, thereby relaxing, and providing slack to the belt 262, generally precluding torque transmission from the engine 18 to the drive shaft 64. As such, when the engine 18 is in its disengaged position, the driven member 68 tends to remain idle relative to the drive member 260, regardless of whether the drive member 260 is rotating.

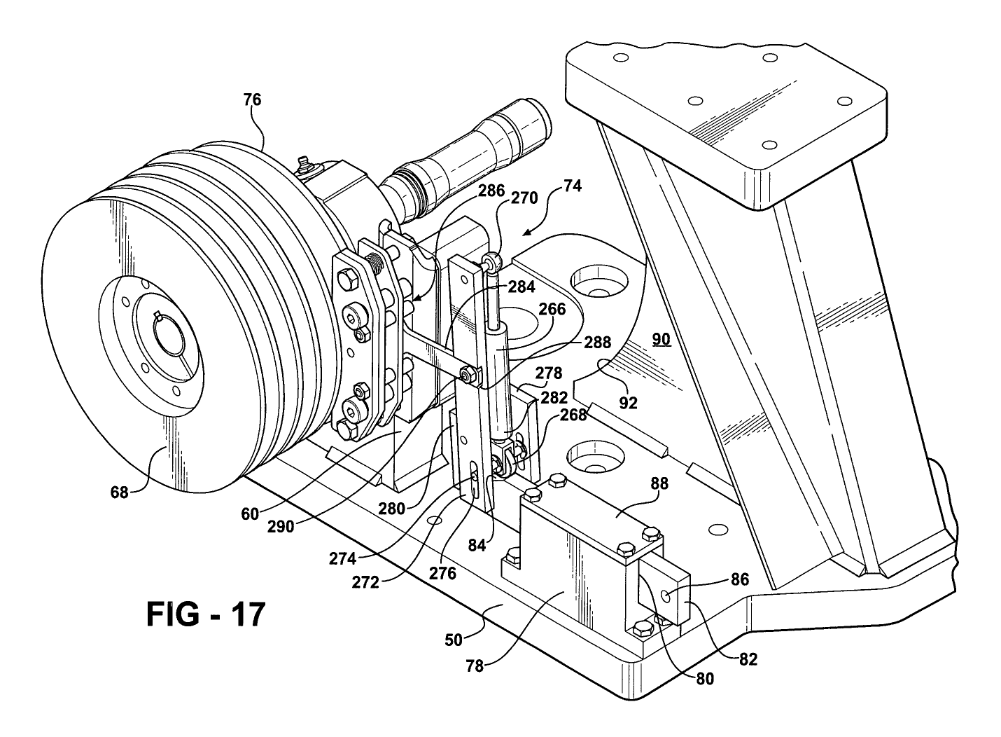

As shown in FIGS. 16 and 17, the brake assembly 74 may be provided to prevent rotation of the cutter 56 as the lever 230 is moved from the first position toward the second position, wherein the brake assembly 74 continues to prevent rotation of the cutter 56 until the lever 230 is moved into the first position. The brake assembly 74 preferably includes a turnbuckle 264 with one end arranged for attachment to the carriage 218, such as via a pin or bolt, and another end arranged for attachment to the actuator bar 82 via the through opening 86. The turnbuckle 264 is preferable adjustable, as discussed above, to allow fine adjustment of the braking action. As the carriage 218 is moved toward the second position, the actuator bar 82 is pushed within the guide housing 78 into cammed engagement with a dampener, such as a gas shock 266, for example. The gas shock 266 preferably has a roller 268 at one end for rolling engagement with the cam surface 84 on the actuator bar 82. The gas shock 266 has another end 270 arranged for attachment to a link arm 272. Preferably, a pin 274 extends laterally through the roller 268 and outwardly therefrom to for guided linear movement along an elongate slot 276 in the link arm 272. The pin 274 and roller 268 are preferably further guided by a support member 278 laterally spaced from the link arm 272 by a wall 280. The support member 278 has a slot 282 in mirrored relation to the slot 276 in the link arm 272 to receive the pin 274 for guided movement therein. As such, when the gas shock 266 is acted on by the actuator bar 82, the link arm 272 is caused to move generally upwardly and downwardly, thereby causing a lever arm 284 to move in response to the movement of the actuator bar 82.

The lever arm 284 is arranged in operable communication with the disc brake assembly 74 to automatically actuate the disc brake when the carriage 218 is moved toward the second position. The lever arm 284 is shown here, by way of example and without limitations, as being operably associated with a caliper 286 of the disc brake. The lever arm 284 has one end arranged for attachment to the link arm 272, and is shown here as preferably being received in a recess 288 in the link arm 272, and further attached via a fastener, such as bolt 290, for example. The other end of the lever arm 284 is in operable communication with the caliper 286, such that movement of the lever arm 284 upwardly in response to movement of the carriage 218 causes the caliper 286 to close brake pads on the disc 76, thereby inhibiting rotation of the drive shaft 64, and ultimately the cutter 56. Accordingly, when the carriage 218 moves the engine to its disengaged position, the cutter 56 is automatically stopped via the brake assembly 76. When the carriage 218 is moves to the engine 18 to its engaged position, the brake assembly 74 is automatically disengaged, thus allowing the cutter 56 to rotate, as commanded.

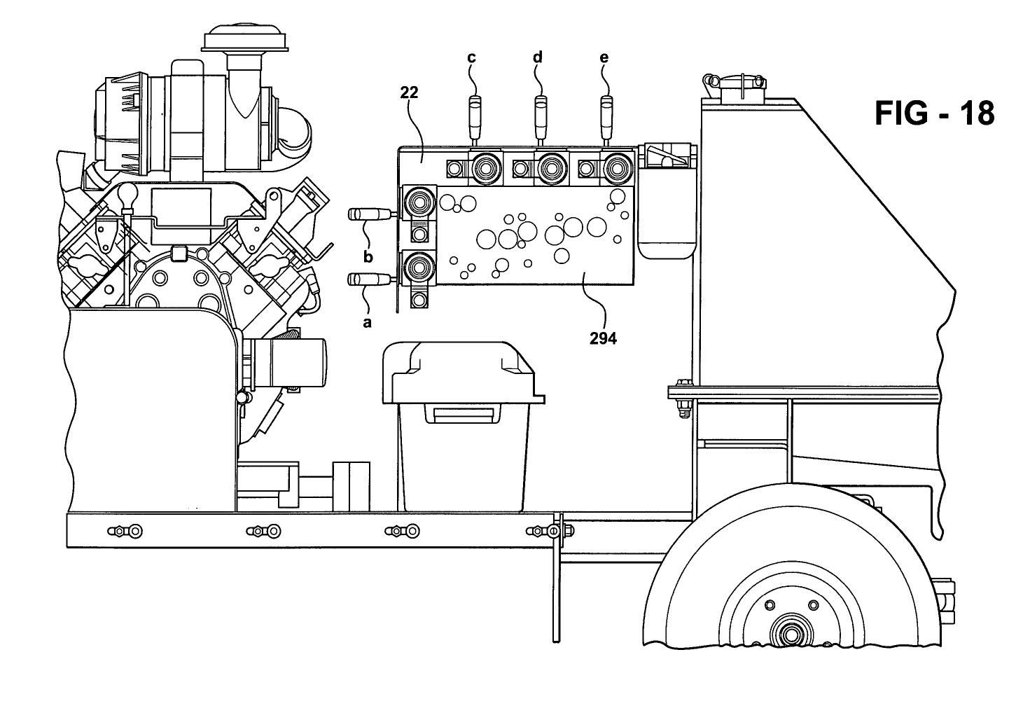

As shown in FIG. 18, the control panel 22 includes a valve manifold 294 preferably constructed from a relatively compact, single piece of material, such as aluminum, for example. As shown in FIGS. 18 and 19 a plurality of control levers (a, b, c, d, e) are pivotally attached to the control center 22 to facilitate manually and mechanically actuating the respective actuable mechanisms discussed above. The actuable mechanisms are actuable remotely, such as by way of a hard-wired or wireless remote control. The manually operated levers (a, b, c, d, e) are constructed to over-ride the remote operation of the mechanisms.

A first control lever (a) actuates a propulsion flow control valve V1 that is carried by the manifold 294 and is connected in fluid communication between the manifold 294 and wheel drive motors 24. Actuation of the propulsion flow control valve V1 directs pressurized hydraulic fluid from the manifold 294 to the wheel motors 24 that direct forward and reverse movement of the rear driven wheels 14, propelling the machine 10 across the ground.

A second control lever (b) actuates steering flow control valve V2 that is carried by the manifold 294 and is connected in fluid communication between the manifold 294 and the hydraulic steering actuator 42 connected to at least one of the wheels 16. Actuation of the steering flow control valve V2 directs pressurized hydraulic fluid from the manifold 294 to the steering actuator to steer the machine 10 as it moves across the ground.

A third control lever (c) actuates a swing flow control valve V3 that is carried by the manifold 294 and is connected in fluid communication between the manifold 294 and the swing actuators 105, 106 connected to the arm 58. Actuation of the swing flow control valve V3 directs pressurized hydraulic fluid from the manifold to the swing actuators 105, 106 to pivot the arm 58 about the arm yaw axis, thus controlling the right and left swinging movement of the arm 58.

A fourth control lever (d) actuates an arm pitch control valve V4 that is carried by the manifold 294 and is connected in fluid communication between the manifold 294 and the arm pitch actuator 124 connected to the arm 58. Actuation of the arm pitch control valve V4 directs pressurized hydraulic fluid from the manifold 294 to the arm pitch actuator 124 to pivot the arm 58 about the arm pitch axis.

A fifth control lever (e) actuates a plow control valve V5 that is carried by the manifold 294 and is connected in fluid communication between the manifold 294 and the hydraulic plow actuator 45 connected to the plow 44. Actuation of the plow control valve V5 directs pressurized hydraulic fluid from the manifold 294 to the plow actuator 45 to move the plow 44 up and down.

As shown in FIG. 19, each control lever (a-e) is in operable communication, preferably mechanically, with one of the solenoid control valves V1, V2, V3, V4, V5, respectively. The control valves V1-V5 are tandem spool, spring centered, 4-way, 3-position solenoid-manual directional control valves that regulate the flow of hydraulic fluid throughout the hydraulic circuit. The control valves V1, V2, V3, V4, and V5 are preferably arranged in series throughout the hydraulic fluid flow circuit, with a relief valve RV being arranged to prevent system hydraulic pressure from exceeding a predetermined maximum value.

In use, the control valves V1, V2, V3, V4, and V5 generally remain in their centered, closed position, until the respective control lever (a-e) is pivoted in the intended direction, thereby causing the respective control valve to move to one of two open positions. If the machine is being operated via remote control, then the control valves V1, V2, V3, V4, and V5 are actuated via the remote control, rather than the control levers (a-e). When a respective one or more of the control valves V1, V2, V3, V4, V5 is moved to one open position, the hydraulic fluid is routed through the respective control valve in a first direction downstream of the control valve, and when moved to the other open position, the hydraulic fluid is routed in a second direction downstream of the control valve opposite the first direction. As such, the direction of fluid flow downstream of the respective control valve, and the direction of movement of the associated actuator being commanded, is determined by the direction in which the respective control valve is moved, whether it is via the associated control lever or via remote control. In any case, movement of each control lever (a-e) in one direction causes the respective hydraulic actuator, and thus, the mechanism it controls to move in one direction, and vice versa.

The flow of hydraulic fluid bypasses the control valves V1, V2, V3, V4, V5 when the control valves are in their closed position, wherein the hydraulic fluid may be recirculated back to the hydraulic fluid tank 26. The hydraulic fluid may be directed to flow through a filter 292 to remove any impurities from the fluid.

In addition to the control valves V1, V2, V3, V4, V5 associated with the aforementioned control levers (a-e), a brake bypass system 294 may be incorporated in the hydraulic system. The brake bypass system 294 includes a first shuttle valve 296 and a second shuttle valve 298, a tow valve 300 and a pump 302, wherein the pump 302 may be in operable communication with a relief valve 304. The brake bypass system 294 enables the brake cylinders 30 to be disengaged from the wheel motors 24, wherein the brakes are normally spring biased in their engaged state while the main engine 18 is not running and/or while the wheel motors 24 are not actuated. When the main engine 18 is running, and the rear wheels 14 are commanded to move via the first control lever (a), the first and second shuttle valves 296, 298 are automatically moved to a position to allow hydraulic fluid to flow to the brake cylinders 24, thereby causing them to become disengaged (FIG. 19 shows the first and second shuttle valves in an opposite position to that just described).

To disengage the brakes 32 while the engine 18 is not running, the tow valve 300, which ordinarily remains in a closed position, is moved to an open position. This may be accomplished by activating a switch or control knob on the control panel 22. With the tow valve 300 in the open position, any fluid pressure build-up within the hydraulic wheel motors 24 is relieved by allowing the hydraulic fluid to recirculate. The pump 302 is then actuated, such as with an electrically driven pump or a manually actuated hand pump 305. The pump 305 generates a relative high pressure within the brake cylinders 24 by causing the second shuttle valve 298 to move to a position which allows hydraulic fluid to flow to the brake cylinders 24. The relative high pressure hydraulic fluid within the brake cylinders 24 overcomes the bias imparted by the springs 34, thereby causing the brakes to disengage the wheel motors 24. The relief valve 304 alleviates any excess build-up of fluid pressure.

Additionally, a 50-50 fluid flow divider 306 may be incorporated for fluid communication with a fluid flow control valve 308, represented here, by way of example and without limitations, as a single spool, 3-way, 2-position solenoid-manual directional control valve, to equally divide the flow of hydraulic fluid into parallel fluid flow paths P1, P2 when the fluid flow control valve 308 is in one position as shown in FIG. 19. As such, separate ones of the paths P1, P2 are provided to separate ones of the wheel motors 24. The paths P1, P2 provide generally equal parallel fluid flow to the wheel motors 24 to drive the wheel motors 24 in a low speed, dual wheel drive or posi-traction mode. When in this mode, one wheel 14 is substantially assured of being driven, regardless of what the other wheel 14 is doing.

The hydraulic system may also have a divider bypass valve 310, represented here as a standard solenoid valve, that when opened (not shown), preferably automatically causes the fluid flow control valve 308 to be moved to its other position. As such, when the bypass valve 310 is opened, the 50-50 fluid flow divider 306 is bypassed, thereby establishing a series fluid flow condition to the wheel motors 24 to drive the wheel motors 24 in a high speed, posi-traction mode.

Further, a pair of cross piloting fluid flow regulator valves 312, 313 may be arranged for fluid communication with one another between the control valve V1 and the wheel motors 24. The regulator valves 312, 313 cooperate with one another to facilitate regulating the flow of hydraulic fluid to and from the wheel motors 24 to ensure they are running at the commanded speed. This is particularly important on inclined ground surfaces where the machine would otherwise have a tendency to free wheel or gain speed down the inclined surface if the wheel motors 24 were not prevented from doing so. The regulator valves 312, 313 prevent hydraulic fluid from flowing away from the motors 24 at a quicker rate than the fluid flow to the motors 24, thereby regulating the speed of the wheel motors 24, and maintaining the machine 10 at the desired velocity.

The fluid flow regulator valves 312, 313 have a pair of ball valves 314 that are automatically actuable via fluid flow pressure to facilitate maintaining the proper flow of fluid to and away from the wheel motors 24. In addition, the valves 312, 313 may be biased by springs 316 to ordinary equal one-to-one flow rate positions with one another to facilitate maintaining the proper flow of fluid to and away from the motors 24. If the bias imparted by one of the springs 316 is overcome by an increase in fluid pressure, the respective valve is automatically moved to a reduced flow rate position, such as a four-to-one ratio, for example, wherein the returning fluid flow rate from the motors 24 is cross-piloted with the other valve to prevent unwanted accelerations of the wheel motors 24 and the machine 10.

In operation, prior to positioning the cutter 56 in its desired cutting position, the carriage 218 maintains the engine 18 in its disengaged position via the lock arm 248. As such, ordinarily, the brake of the brake assembly 74 is automatically applied to the disk 76 to prevent the cutter 56 from rotating.

If the machine 10 needs to be moved, the first control lever (a) may be manipulated to drive the wheel motors 24, thereby automatically disengaging the motor brake cylinders 30, thus, allowing the machine 10 to be driven in a forward or reverse direction, as commanded. Depending on the terrain, the machine 10 can be selectively driven in the low speed or high speed mode by utilizing the parallel flow paths P1, P2, or the series flow path. The second control lever (b) can also be used to steer the wheels 16 in the desired direction. If debris needs to be cleared from the path of the machine 10, the fifth control lever (e) can be manipulated to lower the plow 44 into the plowing position. The first and second control levers (a, b), respectively, are then released to their neutral positions, thereby returning the respective control valves V1, V2 to their centered, closed positions, and automatically causing the motor brake cylinders 30 to return to their engaged positions under the bias of the springs 34.

Upon orienting the cutter 56 in its desired cutting position, the lock arm 248 is removed from its locked position, thereby enabling the carriage 218 and engine 18 to be moved along the rails 220 conjointly relative to the grinder assembly 20 via the lever 230 until the engine 18 is in its fully engaged position. As such, the brake assembly 74 is automatically disengaged from the disk 76, thereby allowing the driven member 68 and drive shaft 64 to be driven via the belt 262 in response to rotation of the drive member 260. The fourth control lever (d) is then manipulated to lower the arm 58 and cutter 56 to the desired cutting height to begin grinding the tree stump. The third control lever (c) may be manipulated to move the arm 58 and cutter 56 in a swinging left and right direction until the tree stump is removed to the depth of the cutter teeth 204.

The arm 58 and cutter 56 can be pivoted outwardly from the sides of the machine 10 without causing the machine 10 to become unstable or tip since the full weight of the main engine 18 is maintained toward the center of the frame 12. As such, the machine 10 is well balanced in use, regardless of the position of the cutter 56.

Upon completing the initial cutting pass, the arm 58 and cutter 56 can be further lowered via the forth control lever (d), if necessary. This process is repeated until the stump is removed to the desired depth, typically below ground level.

Again, with the machine 10 being well balanced, the depth of cut can be maximized without causing the machine 10 to become unstable. If a depression is created while removing the stump, the fifth control lever (e) can be manipulated to lower the plow 44 into the plowing position to facilitate back-filling the hole.

Accordingly, the machine 10 provides an effective and efficient mechanism for removing tree stumps through the use of controls contained within a relatively small area and within a single control panel 22, and further, via remote control operation. The embodiments of the machine 10 discussed above are intended to be illustrative of some presently preferred embodiments of the invention, and are not limiting. Various modifications within the spirit and scope of the invention will be readily apparent to those skilled in the art. For example, the number of control levers and associated control valves can be varied, depending on the nature of the application. The invention is defined by the claims that follow.

We claim:

1. A grinding machine for reducing wood objects to fragments, the grinding machine comprising:
a frame supported for movement over the ground;
an engine carried by the frame;
an arm operably supported on the frame for pivotal movement relative to the frame and the engine;
a grinding member carried by the arm for pivotal movement with the arm; and
a drive transmission linkage operably connected between the engine and the grinding member and configured to transmit torque from the engine to the grinding member even as the arm pivots the grinding member relative to the frame and the engine.

2. The grinding machine of claim 1 in which the drive transmission linkage includes:
a drive shaft driven by the engine; and
a driven shaft operatively attached to the drive shaft for rotation with the drive shaft and arranged for pivotal movement relative to the drive shaft, the driven shaft being arranged in operable communication with the fragmenting assembly to drive the fragmenting assembly.

3. The grinding machine of claim 2 in which the driven shaft pivots relative to the drive shaft in response to the arm pivoting relative to the frame.

4. The grinding machine of claim 3 in which the driven shaft is pivotable through an arc of about 80 degrees relative to the drive shaft.

5. The grinding machine of claim 3 in which the grinding member is pivotable through an arc of about 80 degrees relative to the frame.

6. The grinding machine of claim 3 in which:
the pivotal movement of the arm relative to the frame includes a yaw component about an arm yaw axis and a pitch component about an arm pitch axis generally perpendicular to the arm yaw axis; and
the pivotal movement of the driven shaft relative to the drive shaft includes a yaw component about a transmission yaw axis and a pitch component about a transmission pitch axis generally perpendicular to the transmission yaw axis.

7. The grinding machine of claim 6 in which:
the driven shaft is pivotable through an arc of about 80 degrees relative to the drive shaft in any azimuth; and
the arm is pivotable through an arc of about 80 degrees relative to the frame in any azimuth.

8. The grinding machine of claim 1 in which the drive transmission linkage includes a constant velocity joint operably coupling the drive shaft to the driven shaft.

9. The grinding machine of claim 1 in which the drive transmission linkage includes a belt drive operably connected between the engine and the grinding member.

10. The grinding machine of claim 1 in which:
the engine is supported on the frame for movement between engaged and disengaged positions;
the grinding member is operable to rotate in response to actuation of the engine when the engine is in the engaged position; and
the grinding member is inoperable when the engine is in the disengaged position.

11. The grinding machine of claim 10 in which:
the drive transmission linkage is configured to transmit torque to and rotate the grinding member when the engine is operating in its engaged position; and
the drive transmission linkage is configured to prevent rotation of the grinding member when the engine is in its disengaged position.

12. The grinding machine of claim 11 in which:
the drive transmission linkage includes a belt drive operably connected between the engine and the grinding member, the belt drive comprising:
a drive pulley supported on the engine for driven rotation,
a driven pulley supported on a drive shaft of the transmission linkage that is drivingly connected to the grinding member, and
a belt supported between the drive pulley and the driven pulley;
the belt is held in tension between the drive and driven pulleys when the engine is in its engaged position, allowing torque transmission from the engine to the drive shaft; and
the belt is relaxed when the engine is in its disengaged position, generally precluding torque transmission from the engine to the drive shaft.

13. The grinding machine of claim 10 further comprising a brake that is actuable to prevent the grinding member from rotating, the brake being automatically actuated when the engine is moved to its engaged position and automatically released when the engine is moved to its disengaged position.

14. The grinding machine of claim 13 in which the brake comprises a disc brake.

15. The grinding machine of claim 1 in which:
the machine includes a hydraulic manifold supported on the frame and in fluid communication with a source of pressurized hydraulic fluid;
the machine includes a swing actuator connected to the arm and configured to pivot the arm about a yaw axis;
the machine includes a swing flow control valve carried by the manifold, connected in fluid communication between the swing actuator and the manifold, and actuable to direct pressurized hydraulic fluid from the manifold to the swing actuator to pivot the arm about the yaw axis;
the machine includes an arm pitch actuator connected to the arm and configured to pivot the arm about a pitch axis; and
the machine includes an arm pitch flow control valve carried by the manifold, connected in fluid communication between the arm pitch actuator and the manifold, and actuable to direct pressurized hydraulic fluid from the manifold to the arm pitch actuator to pivot the arm about the pitch axis.

16. The grinding machine of claim 15 in which the machine includes a relief valve configured to prevent hydraulic pressure from exceeding a predetermined maximum value.

17. The grinding machine of claim 15 in which:
the frame is supported for movement on wheels;
the machine includes a hydraulic steering actuator connected to at least one of the wheels and configured to steer the wheel; and
the machine includes a steering flow control valve carried by the manifold, connected in fluid communication between the steering actuator and the manifold, and actuable to direct pressurized hydraulic fluid from the manifold to the steering actuator to steer the machine.

18. The grinding machine of 1claim 15 in which:
the frame is supported for movement on wheels;
the machine includes at least one hydraulic drive motor drivingly connected to at least one of the wheels;
the machine includes a propulsion flow control valve carried by the manifold, connected in fluid communication between the drive motor and the manifold, and actuable to direct pressurized hydraulic fluid from the manifold to the drive motor to propel the machine across the ground.

19. A method of reducing wood objects to fragments; the method including the steps of:
providing a grinding machine comprising an engine carried by a frame and an arm operably supported by the frame for pivotal movement relative to the frame and engine, a grinding member carried by the arm for pivotal movement with the arm, and a drive transmission linkage operably connected between the engine and the grinding member;
positioning the grinding machine adjacent a wood object to be fragmented;
actuating the arm to pivotally move the grinding member into engagement with the wood object; and
transmitting torque from the engine to the grinding member via the drive transmission linkage as the arm pivots the grinding member relative to the frame and the engine.

20. A method of reducing wood objects to fragments; the method including the steps of:
providing a grinding machine comprising an engine carried by a frame and an arm operably supported by the frame for pivotal movement relative to the frame and engine, and a grinding member carried by the arm for pivotal movement with the arm;
positioning the grinding machine adjacent a wood object to be fragmented;
actuating the grinding member by moving the engine from a disengaged position to an engaged position; and then
actuating the arm to pivotally move the grinding member into engagement with the wood object.
